(19) United States
(12) Patent Application Publication
(10) Pub. No.: US 2026/0236046 A1
(43) Pub. Date: Aug. 13, 2026

(54) SOLVENT CUP REFILL MECHANISM

(71) Applicant: Nordson Corporation, Westlake, OH (US)

(72) Inventors: Timothy GIRVIN, San Diego, CA (US); Ronny FRANKEN, Maasmechelen (BE)

(73) Assignee: Nordson Corporation, Westlake, OH (US)

(21) Appl. No.: 19/150,989

(22) PCT Filed: Jan. 24, 2024
(86) PCT No.: PCT/US2024/012709

§ 371 Date: Jul. 25, 2025

Related U.S. Application Data
(60) Provisional application No. 63/482,377, filed on Jan. 31, 2023.

(51) Int. Cl. G05D 9/12; B05B 15/55; B08B 3/04

(52) U.S. Cl. CPC G05D 9/12; B05B 15/55; B08B 3/048

(57) ABSTRACT

An applicator cleaning system that may comprise a leveling system that is configured to maintain cleaning fluid in a cleaning container at a predetermined elevation. The leveling system may output the cleaning fluid at the predetermined elevation. For example, the leveling system may cascade excess cleaning fluid that is above the predetermined elevation into an overflow receptacle. Further, the disclosure provides for a leveling system that includes a leveling reservoir that may be fluidly coupled to a cleaning container such that when the cleaning fluid in the leveling reservoir is at the predetermined elevation the cleaning fluid in the cleaning container is at the predetermined elevation.

### CROSS-REFERENCE TO RELATED APPLICATIONS

This application is a National Stage Application of International Patent App. No. PCT/US2024/012709, filed Jan. 24, 2024, which claims the benefit of U.S. Provisional Patent App. No. 63/482,377, filed Jan. 31, 2023, the entire disclosures of both of which are hereby incorporated by reference as if set forth in their entirety herein.

### TECHNICAL FIELD

The present disclosure relates generally to fluid containers for coating systems used for a variety of purposes and, in particular, such as solvent cups for conformal coating systems with coating applicators that are parked in the solvent cups, and a method of using the solvent cups.

### BACKGROUND

Conformal coating is typically the process of applying a dielectric material onto an electrical component, for example, a printed circuit, a printed circuit board (PCB), a device mounted thereon, and/or the like to protect it from moisture, fungus, dust, corrosion, abrasion, vibration, chemicals, tin whiskers, other environmental stresses, and/or the like. Conformal coating materials range from solvent based materials that cure by evaporation of the solvent to “100% solid” conformal coating materials. Common conformal coating materials include silicones, acrylics, urethanes, epoxy synthetic resins, various polymers, and/or the like. When applied to PCBs, an insulative resin film of uniform thickness is typically formed as a solvent evaporates or as a solvent-free material is cured.

Automated selective coating systems are known. Such systems may have conformal coating dispensers that dispense material in various patterns with varying deposition accuracies and that produce coatings with varying thicknesses. During operation, portions of the coating system may retain some of the coating material. For example, the nozzles of the coating dispensers can accumulate coating material due to the nature of the coating material itself, due to particular application processes and patterns, and/or the like. The accumulated coating material can cure, harden, otherwise clog, and/or interfere with continued dispensing of the coating material from the affected dispenser nozzle.

Several mechanisms for cleaning accumulated or residual coating material from nozzles exist in the field. In some scenarios, when the dispenser nozzle is not being used, the dispenser nozzle may be stored in a reservoir having a solvent that interacts with any uncured coating that has accumulated on the nozzle and prevents the uncured coating from curing, solidifying, clogging and/or the like the nozzle. However, the high vapor pressure of the solvent often leads to quick and undesirable evaporation and level changes in the reservoir. Accordingly, the solvent in the reservoir must be continually monitored and manually replaced as needed. This can increase costs and can be a point of diminished quality if not properly monitored and replenished.

Accordingly, a process and device are needed to ensure an appropriate and/or sufficient solvent supply is maintained for use by a conformal coating system for cleaning.

### SUMMARY

The present application provides for an applicator cleaning system that may comprise a leveling system that is configured to maintain cleaning fluid in a cleaning container at a predetermined elevation. The leveling system may output the cleaning fluid at the predetermined elevation. For example, the leveling system may cascade excess cleaning fluid that is above the predetermined elevation into an overflow receptacle. Further, the disclosure provides for a leveling system that includes a leveling reservoir that may be fluidly coupled to a cleaning container such that when the cleaning fluid in the leveling reservoir is at the predetermined elevation the cleaning fluid in the cleaning container is at the predetermined elevation.

The leveling system may include multiple leveling reservoirs at different elevations. The leveling reservoirs may be adjacent to one another, such that a high elevation leveling reservoir may cascade into a lower elevation leveling reservoir. The excess cleaning fluid in the high elevation leveling reservoir may cascade into the overflow receptacle via the lower elevation leveling reservoir (or multiple lower elevation leveling reservoirs), such that excess cleaning fluid in the lower elevation leveling reservoir may cascade directly into the overflow receptacle.

The leveling system may be remote from the cleaning container (or multiple cleaning containers) of a conformal coating system. Also, the leveling system may not include fluid level sensor.

A pump may constantly provide cleaning fluid to the leveling system.

For example, excess cleaning fluid may cascade into the overflow receptacle (e.g., from the leveling reservoir or from a cleaning container) such that the cleaning fluid in the cleaning container may remain at the predetermined elevation. The pump may provide the cleaning fluid at or above a predetermined flow rate (e.g., above an expected evaporation rate of the cleaning fluid).

A sensor may sense a flow rate of the cleaning fluid from the pump, to ensure the pump constantly provides the cleaning fluid at or above the predetermined flow rate.

The cleaning container does not need a fluid level sensor to ensure the cleaning fluid is at the predetermined elevation in the cleaning container. Thus, the cleaning container may not include a fluid level sensor that senses the level of cleaning fluid in the cleaning container. Accordingly, the cost and complexity associated with utilizing a fluid level sensor to sense the level of cleaning fluid in the cleaning container are not necessary.

Similarly, the leveling system may not include a fluid sensor to ensure the cleaning fluid is at the predetermined elevation in the leveling reservoir. On the other hand, prior designs for solvent cups may require a fluid level sensor to measure the level of solvent, or a user to regularly check and fill the solvent cups regularly throughout the day to ensure sufficient solvent in the solvent cups.

According to an embodiment of the present disclosure, an applicator cleaning system may comprise a cleaning container, a leveling system, and a pump. The cleaning container may be configured to store a cleaning fluid and configured to receive an applicator for cleaning in the cleaning fluid. The leveling system may be configured to maintain the cleaning fluid in the cleaning container at a predetermined elevation. The leveling system may be configured to output the cleaning fluid at the predetermined elevation. The pump may be configured to provide the cleaning fluid to the leveling system such that the leveling system outputs the cleaning fluid at the predetermined elevation.

According to another embodiment of the present disclosure, an applicator cleaning system may comprise a cleaning container, a leveling system, and a pump. The cleaning container may be configured to store a cleaning fluid and configured to receive an applicator for cleaning in the cleaning fluid. The leveling system may be configured to maintain the cleaning fluid in the cleaning container at a predetermined elevation. The leveling system may include a leveling reservoir that is fluidly coupled to the cleaning container such that when the cleaning fluid in the leveling reservoir is at the predetermined elevation the cleaning fluid in the cleaning container is at the predetermined elevation. The pump may be configured to provide the cleaning fluid to the leveling reservoir.

According to another embodiment of the present disclosure, a method of implementing an applicator cleaning system may comprise storing a cleaning fluid in a cleaning container and configuring the cleaning container to receive an applicator for cleaning in the cleaning fluid. The method may further comprise maintaining the cleaning fluid in the cleaning container at a predetermined elevation with a leveling system. The leveling system may be configured to output the cleaning fluid at the predetermined elevation. The method may further comprise providing the cleaning fluid to the leveling system with a pump such that the leveling system outputs the cleaning fluid at the predetermined elevation.

Any of the features of the above and below disclosed embodiments of the applicator cleaning systems may be used in combination with one another. For example, an applicator cleaning system may include the leveling system and cleaning containers of the first embodiment in combination with the cleaning containers of the second embodiment.

### BRIEF DESCRIPTION OF THE DRAWINGS

The foregoing summary, as well as the following detailed description of illustrative embodiments of the applicator cleaning system of the present application, will be better understood when read in conjunction with the appended drawings. For the purposes of illustrating the applicator cleaning system of the present application, there is shown in the drawings illustrative embodiments. It should be understood, however, that the application is not limited to the precise arrangements and instrumentalities shown. In the drawings:

FIG. 1 is a front schematic view of an applicator cleaning system;

FIG. 2A is a front oblique view of cleaning containers of the applicator cleaning system of FIG. 1;

FIG. 2B is a front oblique view of a leveling system of the applicator cleaning system of FIG. 1;

FIG. 2C is a front oblique view of a system reservoir of the applicator cleaning system of FIG. 1;

FIG. 3 is a front schematic view of another applicator cleaning system, which includes cleaning containers that act as leveling reservoirs that overflow into respective overflow receptacles; and

FIG. 4 is a front schematic view of a coating system that includes the applicator cleaning system of FIG. 1.

### DETAILED DESCRIPTION OF ILLUSTRATIVE EMBODIMENTS

The present disclosure can be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the scope of the present disclosure. Also, as used in the specification including the appended claims, the singular forms “a,” “an,” and “the” include the plural, and reference to a particular numerical value includes at least that particular value, unless the context clearly dictates otherwise.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

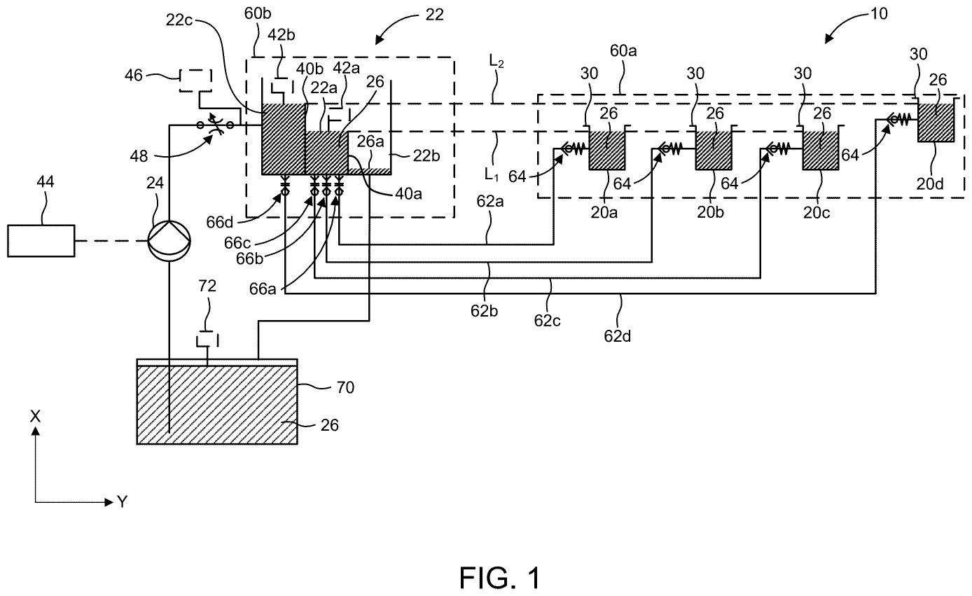

Referring to FIG. 1, an applicator cleaning system 10 may include one or more cleaning containers 20a, 20b, 20c, and 20d (e.g., solvent cups), a leveling system 22, and a pump 24 configured to provide a cleaning fluid 26 to the leveling system.

The cleaning containers 20a, 20b, 20c, and 20d may each comprise the containers disclosed in U.S. Provisional Application No. 63/400,436 filed Aug. 24, 2022 and entitled “DEVICES AND METHODS FOR MINIMIZING EVAPORATION, MAINTAINING ACCESSIBILITY, AND TRIGGERING REFILL OR ULTRASONIC ROUTINES IN CONFORMAL COATING APPLICATIONS,” which is hereby incorporated by reference in its entirety.

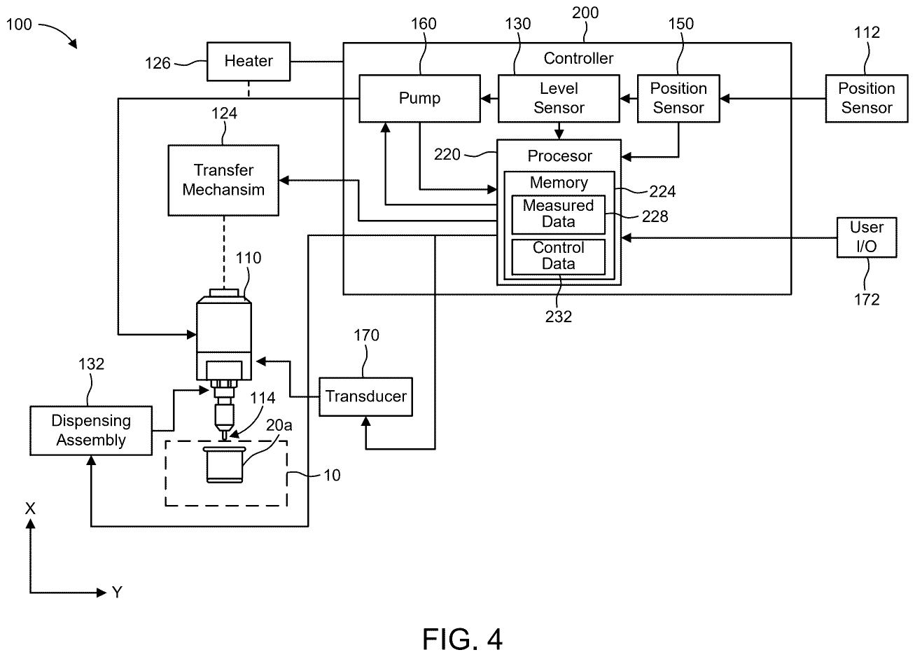

Each cleaning container 20a, 20b, 20c, and 20d may be configured to store the cleaning fluid 26 (e.g., a solvent) for cleaning an applicator, such as an applicator 110 of a conformal coating system 100 illustrated in FIG. 4. The cleaning containers 20a, 20b, 20c, and 20d may be configured to receive an applicator for cleaning in the cleaning fluid. Further, the number of the cleaning containers illustrated and described herein is merely exemplary. In aspects of the disclosure, there may be any number of the cleaning containers.

In an embodiment, the cleaning containers 20a, 20b, 20c, and 20d include an abrasive or rough surface (e.g., a hook side of a hook and loop fastener) that is configured to contact the applicator 110 when the applicator 110 is received in the corresponding cleaning container. In some embodiments, the cleaning containers may each be configured to receive more than one of the applicators simultaneously (e.g., one cleaning container may be configured to receive all of the applicators simultaneously).

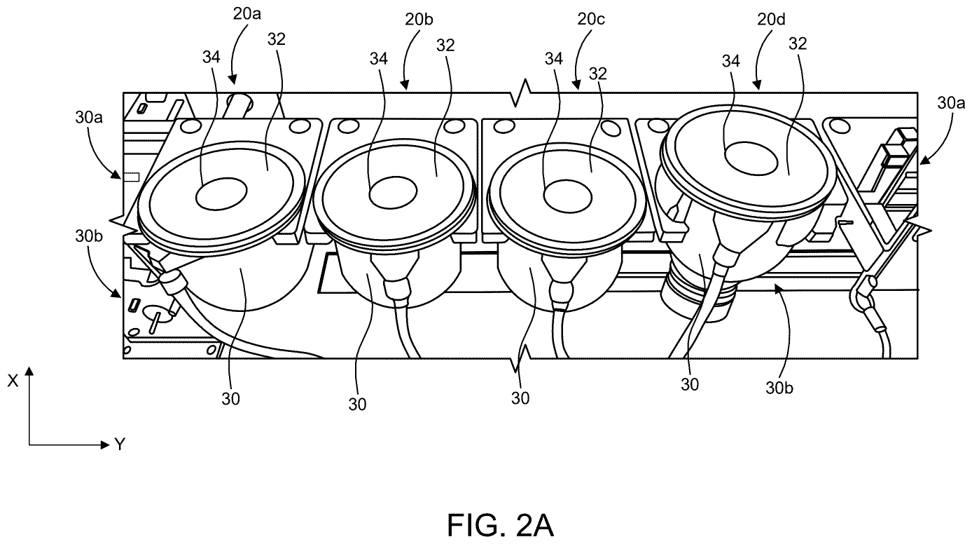

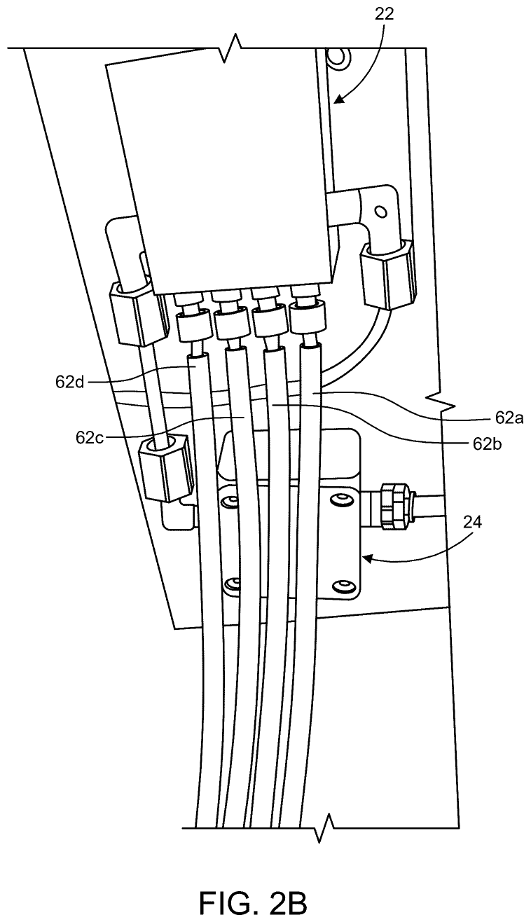

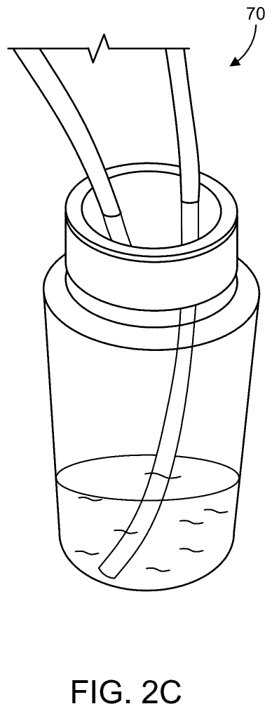

As shown in FIG. 2A, each cleaning container 20a, 20b, 20c, and 20d may include a body 30 and a lid 32. Each body 30 may be configured to store the cleaning fluid 26. In aspects of the disclosure, implementations of the cleaning containers may be implemented without the lid 32.

Each cleaning container 20a, 20b, 20c, and 20d may be configured to receive the applicator 110. For example, each body 30 may define an open portion at its upper end 30a, opposite a lower end 30b along a vertical axis X. Each lid 32 may include a respective through hole 34 configured, arranged, sized, and/or the like such that the applicator 110 may be received by the respective through hole 34 to reach the cleaning fluid 26 stored by the respective body 30.

The body 30 may be formed of a material that may withstand prolonged exposure to the cleaning fluid 26. In aspects, the material of the body 30 may be a metallic material, a synthetic material, and/or the like. In aspects, the material of the body 30 may be stainless steel, steel, aluminum, and/or the like. The body 30 may be configured so as to prevent and/or retard evaporation of the cleaning fluid 26 stored by the body 30.

Turning again to FIG. 1, the leveling system 22 may be configured to maintain the cleaning fluid 26 in each cleaning container 20a, 20b, and 20c at a first predetermined elevation L₁. The first predetermined elevation L₁ may be above a ground elevation (e.g., of Earth). The body 30 of each cleaning container 20a, 20b, and 20c may define a wall that is higher than the first predetermined elevation L₁, such that the cleaning fluid 26 stored in the body 30 may rise without spilling from the respective cleaning container 20a, 20b, and 20c (e.g., upon receipt of the applicator 110).

For example, the leveling system 22 may include a leveling reservoir 22a and an overflow receptacle 22b. The leveling reservoir 22a may be fluidly coupled to each cleaning container 20a, 20b, and 20c such that when the cleaning fluid 26 in the leveling reservoir 22a is at the first predetermined elevation L₁ the cleaning fluid 26 in each cleaning container 20a, 20b, and 20c is at the first predetermined elevation L₁. It should be appreciated that any number of the cleaning containers may be fluidly coupled to the leveling reservoir 22a.

The leveling system 22 may be configured to output the cleaning fluid 26 at the first predetermined elevation L₁. For example, the leveling reservoir 22a may be configured to output excess cleaning fluid 26a of the cleaning fluid 26 at the first predetermined elevation L₁ to the overflow receptacle 22b.

The leveling reservoir 22a may be configured to cascade excess cleaning fluid 26a that is above the first predetermined elevation L₁ into the overflow receptacle 22b. For example, the leveling reservoir 22a may have an open top such that the excess cleaning fluid 26a cascades (e.g., pours) from the leveling reservoir 22a at the first predetermined elevation L₁ into the overflow receptacle 22b. A wall 40a that defines a portion of the leveling reservoir 22a and the overflow receptacle 22b may be the shortest wall that defines the leveling reservoir 22a, such that the excess cleaning fluid 26a cascades over the wall 40a from the leveling reservoir 22a into the overflow receptacle 22b. In an embodiment, the wall 40a may define an outlet port that is configured to output any excess cleaning fluid 26a that is above the first predetermined elevation L₁ from the leveling reservoir 22a into the overflow receptacle 22b.

The leveling system 22 may further include an upper leveling reservoir 22c that is configured to output excess cleaning fluid 26a to the overflow receptacle 22b, via the leveling reservoir 22a. The upper leveling reservoir 22c may be fluidly coupled to the cleaning container 20d, such that when the cleaning fluid 26 in the upper leveling reservoir 22c is at a second predetermined elevation L₂ and the cleaning fluid 26 in the cleaning container 20d is at the second predetermined elevation L₂. The second predetermined elevation L₂ may be above the ground elevation and the first predetermined elevation L₁.

The body 30 of the cleaning container 20d may define a wall that is higher than the second predetermined elevation L₂, such that the cleaning fluid 26 stored in the body 30 can rise without spilling from the cleaning container 20d (e.g., upon receipt of the applicator 110).

In an embodiment, the upper leveling reservoir 22c is fluidly coupled to one or more additional cleaning containers. In an embodiment, the leveling system does not include the upper leveling reservoir 22c. In an embodiment, one or more additional leveling reservoirs may be fluidly coupled to other cleaning containers and configured to output excess cleaning fluid to the overflow receptacle 22b.

Thus, the leveling system 22 may be configured to output the cleaning fluid 26 at the second predetermined elevation L₂. For example, the upper leveling reservoir 22c may be configured to output excess cleaning fluid 26a at the second predetermined elevation L₂ to the overflow receptacle 22b.

The upper leveling reservoir 22c may be configured to cascade excess cleaning fluid 26a that is above the second predetermined elevation L₂ into the overflow receptacle 22b. For example, the upper leveling reservoir 22c may have an open top such that the excess cleaning fluid 26a cascades (e.g., pours) from the upper leveling reservoir 22c at the second predetermined elevation L₂ into the leveling reservoir 22a, and then cascades from the leveling reservoir 22a to the overflow receptacle 22b. A wall 40b that defines a portion of the upper leveling reservoir 22c and the leveling reservoir 22a may be the shortest wall that defines the upper leveling reservoir 22c and the leveling reservoir 22a, such that the excess cleaning fluid 26a cascades over the wall 40b from the upper leveling reservoir 22c to the leveling reservoir 22a, and then into the overflow receptacle 22b. In an embodiment, the wall 40b may define an outlet port that is configured to output any excess cleaning fluid 26a that is above the second predetermined elevation L₂ from the upper leveling reservoir 22c into the leveling reservoir 22a, and then into the overflow receptacle 22b.

The leveling system 22 may be remote from the cleaning containers 20a, 20b, 20c, and 20d. For example, the leveling reservoirs 22a and 22c and/or the overflow receptacle 22b may be entirely offset from the cleaning containers 20a, 20b, 20c, and 20d along a horizontal axis Y that is perpendicular to the vertical axis X.

The leveling system 22 may include fluid level sensors 42a and 42b that are configured to detect a level of the cleaning fluid 26 in the corresponding leveling reservoir 22a or 22c.

A controller 44 of the applicator cleaning system 10 may be configured to communicate with the fluid level sensors 42a and 42b. For example, the controller may be configured to maintain a level of the cleaning fluid 26 in the leveling reservoir 22a at the first predetermined elevation and configured to maintain a level of the cleaning fluid 26 in the upper leveling reservoir 22c at the second predetermined elevation. In an embodiment, the fluid level sensor 42a and/or the fluid level sensor 42b is not provided.

The applicator cleaning system 10 may include a flow sensor 46 that is configured to measure a flow rate of the cleaning fluid 26 that is pumped by the pump 24 to the leveling system 22. The controller 44 may be configured to communicate with the flow sensor 46 to maintain the flow rate at or above a predetermined threshold, such that the cleaning fluid 26 in the leveling system 22 is maintained such that the leveling reservoirs 22a and 22c remain filled and overflowing into the overflow receptacle 22b. Maintaining the leveling reservoirs 22a and 22c filled and overflowing may thereby result in maintaining the cleaning fluid 26 in the cleaning containers 20a, 20b, and 20c at the first predetermined elevation L₁ and maintaining the cleaning fluid 26 in the cleaning container 20d at the second predetermined elevation L₂.

The applicator cleaning system 10 may include a flow control valve 48 that is configured to adjust flow of cleaning fluid 26 from the pump 24 to the leveling system 22. The controller 44 may be configured to communicate with the flow valve 48 to maintain the flow rate at or above the predetermined threshold (e.g., based on feedback from the flow sensor 46).

In an embodiment, the leveling system 22 and/or cleaning containers 20a, 20b, 20c, and 20d may be configured to adjust their respective heights. Adjusting the heights may provide for ensuring that the cleaning containers 20a, 20b, 20c, and 20d are filled to a predetermined level within the respective body 30 (e.g., about 90% of the respective body 30 may be filled).

For example, the cleaning containers 20a, 20b, 20c, and 20d may be mounted to an adjustable bracket 60a (not illustrated in FIG. 2A) and/or the leveling system 22 may be mounted to an adjustable bracket 60b (not illustrated in FIG. 2A). The adjustable bracket 60a may be configured to adjust a height of each of the cleaning containers 20a, 20b, 20c, and 20d along the vertical axis X relative to the leveling system 22. For example, the adjustable bracket 60a may be adjustable such that one or more of the cleaning containers 20a, 20b, and 20c may be moved upward or downward relative to the first predetermined elevation L₁ and maintained in its position after such movement. Similarly, the adjustable bracket 60a may be adjustable such that the cleaning container 20d may be moved upward or downward relative to the second predetermined elevation L₂ and maintained in its position after such movement.

The adjustable bracket 60b may be configured to adjust a height of the leveling system 22 such that the height of the leveling reservoirs 22a and/or 22c are adjusted, thereby adjusting the respective first predetermined elevation L₁ and/or the second predetermined elevation L₂ along the vertical axis X. For example, the adjustable bracket 60b may be adjustable such that the leveling reservoirs 22a and 22c along with the overflow receptacle 22b may be moved upward or downward relative to the cleaning containers 20a, 20b, 20c, and 20d along the vertical axis X and maintained in their position after such movement.

In an embodiment, the output height of the leveling reservoirs may be adjusted by another mechanism. For example, the leveling reservoirs may include a breakaway or movable dam that is configured to adjust the output elevation of the cleaning fluid thereby adjusting the elevation of the cleaning fluid in the corresponding cleaning containers.

The pump 24 may provide the cleaning fluid to the leveling reservoirs 22a and 22c and thereby to overflow receptacle 22b and the cleaning containers 20a, 20b, 20c, and 20d. During use, the cleaning fluid 26 in the cleaning containers 20a, 20b, 20c, and 20d may become contaminated from the applicator 110 and/or another contamination source.

The applicator cleaning system 10 may include fluid lines 62a, 62b, 62c, and 62d that fluidly connect the cleaning containers 20a, 20b, 20c, and 20d with the leveling system 22 and check valves 64 between the leveling system 22 and the cleaning containers 20a, 20b, 20c, and 20d. For example, the fluid lines 62a, 62b, and 62c may fluidly couple the leveling reservoir 22a with the cleaning containers 20a, 20b, and 20c, and the fluid line 62d may fluidly couple the upper leveling reservoir 22c with the cleaning container 20d.

The check valves 64 may be configured to prevent the cleaning fluid 26 in the cleaning containers 20a, 20b, 20c, and 20d from flowing upstream back to the leveling system 22, thereby preventing contaminants that may accumulate in the cleaning containers 20a, 20b, 20c, and 20d from flowing to the leveling system 22.

The leveling system 22 may include quick connects 66a, 66b, 66c, and 66d that are configured to releasably couple the fluid lines 62a, 62b, 62c, and 62d with the respective outlet of the leveling reservoirs 22a and 22c. The quick connects 66a, 66b, 66c, and 66d may be configured to close when disconnected from the respective fluid line 62a, 62b, 62c, or 62d. For example, if the fluid line 62a is disconnected from the leveling reservoir 22a, the quick connect 66a may close, thereby preventing cleaning fluid 26 from spilling from the leveling reservoir 22a. The quick connects 66a, 66b, 66c, and 66d may thus provide for removal and cleaning of one of the fluid lines (e.g., 62a) and/or one of the cleaning containers (e.g., 20a), without disrupting operation of the pump 24, the leveling system 22, the other fluid lines (62b, 62c, and 62d), and/or the other cleaning containers (e.g., 20b, 20c, and 20d). Such removal and cleaning may not require draining, refilling, or priming of the pump 24 or the leveling system 22.

The applicator cleaning system 10 may include a system reservoir 70 that is fluidly coupled to the pump 24 and the leveling system 22. The system reservoir 70 may be configured to store a reserve of the cleaning fluid 26 for the pump 24 to provide to the leveling system 22 and thereby to the cleaning containers 20a, 20b, 20c, and 20d.

The overflow receptacle 22b may be configured to return the excess cleaning fluid 26a from the leveling reservoir 22a to the system reservoir 70. Thus, the cleaning fluid 26 may be constantly provided by the pump 24 to the leveling system 22 and the cleaning containers 20a, 20b, 20c, and 20d without loss of the cleaning fluid (other than loss due to evaporation). Also, the system reservoir 70 may remain free from contaminants that may accumulate in the cleaning containers 20a, 20b, 20c, and 20d due to the check valves 64 preventing backflow from the cleaning containers 20a, 20b, 20c, and 20d to the system reservoir 70 via the leveling system 22.

The system reservoir 70 may include a fluid level sensor 72 (not illustrated in FIG. 2C) that is in communication with the controller 44. The controller 44 may be configured to generate a user alert and/or shut off the pump 24 when the cleaning fluid 26 in the system reservoir 70 is below a predetermined reserve level (e.g., when the system reservoir 70 is at or below 10% its capacity).

During use, the controller 44 may control the pump 24 to constantly pump the cleaning fluid 26 from the system reservoir 70 to the upper leveling reservoir 22c at or above the predetermined flow rate. The cleaning fluid 26 may constantly overflow from the upper leveling reservoir 22c into the leveling reservoir 22a at the second predetermined elevation L₂, thereby maintaining the cleaning container 20d filled with cleaning fluid 26 at the second predetermined elevation L₂. For example, the cleaning fluid 26 may constantly cascade from the upper leveling reservoir 22c into the leveling reservoir 22a (e.g., in a similar manner as a fountain).

Evaporation of any of the cleaning fluid 26 in the cleaning container 20d results in fluid from the upper leveling reservoir 22c flowing to the cleaning container 20d, such that the cleaning fluid in the cleaning container 20d does not fall below the second predetermined elevation L₂.

The excess cleaning fluid 26a may constantly overflow from the leveling reservoir 22a into the overflow receptacle 22b at the first predetermined elevation L₁, thereby maintaining the cleaning containers 20a, 20b, and 20c filled with cleaning fluid 26 at the first predetermined elevation L₁. For example, the excess cleaning fluid 26a may constantly cascade from the leveling reservoir 22a into the overflow receptacle 22b (e.g., in a similar manner as a fountain). The overflow receptacle 22b may return the excess cleaning fluid 26a to the system reservoir 70.

Evaporation of any (or all) of the cleaning fluid 26 in the cleaning containers 20a, 20b, or 20c results in fluid from the leveling reservoir 22a flowing to such cleaning containers 20a, 20b, or 20c, such that the cleaning fluid 26 in the cleaning containers 20a, 20b, and 20c does not fall below the first predetermined elevation L₁.

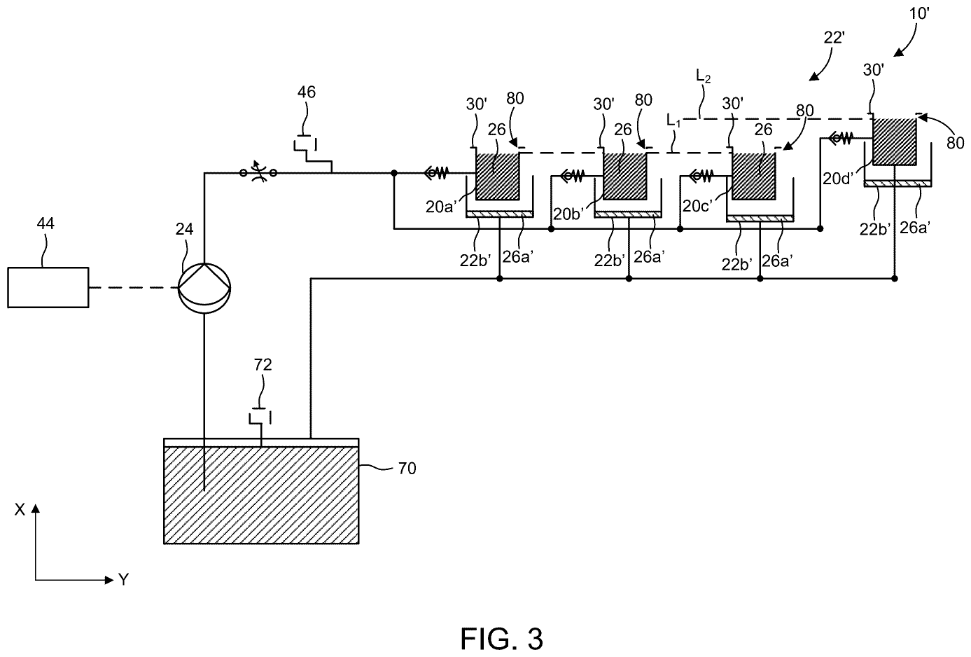

Referring now to FIG. 3, a second embodiment of the applicator cleaning system 10′ is shown. It is to be appreciated that the second embodiment can be similar to the first embodiment of the applicator cleaning system 10 shown in FIG. 1, for example. Accordingly, the same reference numbers used above with reference to the first embodiment can be also used with a “prime” notation in reference to a second embodiment. It is also to be appreciated that, unless otherwise set forth below, the components (and features thereof) of the applicator cleaning system 10 of the second embodiment can be similar to those of the applicator cleaning system 10 of the first embodiment.

The applicator cleaning system 10′ may include one or more cleaning containers 20a′, 20b′, 20c′, and 20d′ (e.g., solvent cups) that define respective leveling reservoirs of a leveling system 22′, the pump 24, and the system reservoir 70. The pump 24 may be configured to provide a cleaning fluid 26 from the system reservoir 70 to the leveling system 22′.

More specifically, the pump 24 may be fluidly coupled to each of the cleaning containers 20a′, 20b′, 20c′, and 20d′. The cleaning containers 20a′, 20b′, 20c′, and 20d′ may each be configured to output fluid to a corresponding overflow receptacle 22b′ at a first predetermined elevation L₁ or at a second predetermined elevation L₂. For example, each cleaning container may include a body 30′ that defines an outlet 80. Each outlet 80 may be configured such that the respective body 30′ remains at most filled to a predetermined level within the respective body 30′ when upright with respect to gravity. For example, at most about 90% of the respective body 30′ may be filled with the cleaning fluid 26.

The cleaning containers 20a′, 20b′, and 20c′ may be arranged such that the respective outlets 80 output the cleaning fluid 26 at the first predetermined elevation L₁. For example, the outlets 80 may be configured to cascade excess cleaning fluid 26a′ at the first predetermined elevation L₁ to the corresponding overflow receptacle 22b′, to return the excess cleaning fluid 26a′ to the system reservoir 70.

The cleaning container 20d′ may be arranged such that the respective outlet 80 outputs the cleaning fluid 26 at the second predetermined elevation L₂. For example, the outlet 80 of the cleaning container 20d′ may be configured to cascade excess cleaning fluid 26a′ at the second predetermined elevation L₂ to the corresponding overflow receptacle 22b′, to return the excess cleaning fluid 26a′ to the system reservoir 70.

The cleaning containers 20a′, 20b′, 20c′, and 20d′ may be fluidly coupled to the pump 24 in parallel with one another. In an embodiment, the cleaning containers 20a′, 20b′, 20c′, and 20d′ may be fluidly coupled to the pump 24 in a different manner. Regardless, the pump and the cleaning containers 20a′, 20b′, 20c′, and 20d′ may be configured such that excess cleaning fluid 26a constantly flows out of each outlet 80 at the corresponding first predetermined elevation L₁ or second predetermined elevation L₂.

The applicator cleaning system 10′ may include the controller 44, the flow sensor 46, and the fluid level sensor 72. The controller 44 may be in communication with the flow sensor 46 and the fluid level sensor 72. For example, the controller 44 may be configured to operate the pump 24 such that the pump 24 maintains the flow rate at or above a predetermined threshold, such that the cleaning fluid 26 in the cleaning containers 20a′, 20b′, 20c′, and 20d′ remain filled and overflowing into the respective overflow receptacle 22b′.

The controller 44 may be configured to generate a user alert and/or shut off the pump 24 when the cleaning fluid 26 in the system reservoir 70 is below a predetermined reserve level (e.g., when the system reservoir 70 is at or below 10% its capacity).

Turning to FIG. 4, a conformal coating system 100 may include the applicator cleaning system 10 (and/or the applicator cleaning system 10′), and a conformal coating implementation of one or more applicators 110.

For example, the cleaning container 20a may store the cleaning fluid 26 (shown in FIG. 1) for cleaning a corresponding applicator 110, as described herein. The applicator 110 may be configured to receive one or more conformal coating materials from a material source 112. The applicator 110 may have an applicator tip 114, through which the applicator 110 is configured to dispense the received material onto one or more substrates (not shown). The dispensing of the material may be controlled by one or more dispensing assemblies 132 within, and/or operably connected to, the applicator 110. The one or more dispensing assemblies 132 may include movable valves, valve components, and/or the like (not shown) and may include an actuator to cause movement of a valve or valve components that may be implemented by, for example, a solenoid.

When idle, each applicator 110 (only one applicator 110 shown in FIG. 4) may be parked in the corresponding cleaning container 20a, 20b, 20c, or 20d (shown in FIG. 1). For example, each respective applicator tip 114 of multiple applicators 110 may be parked in the corresponding cleaning container 20a, 20b, 20c, or 20d.

The conformal coating system 100 may include a heater 126 configured to heat the coating material. The heater 126 may be disposed adjacent the material source 112, the applicator 110, or elsewhere in the conformal coating system 100. In an embodiment, the conformal coating system 100 may include a plurality of heaters 126.

The applicator 110 may be operably connected to a transfer mechanism 124. In some aspects, the transfer mechanism 124 may be configured to move the applicator 110 between an operating or dispensing position and a cleaning position. In the operating position, the applicator 110 is configured to dispense the material onto the substrate. The applicator 110 may be movable relative to the substrate when in the operating position. In the cleaning position, the applicator 110 may be spaced away from the substrate (e.g., proximate to or at least partially within the cleaning container 20a, as described herein) and is precluded from dispensing the material onto the substrate.

The conformal coating system 100 may further include one or more controllers configured to send and/or receive signals to direct operation of the one or more components of the conformal coating system 100. A controller 200 may be configured to send and/or receive data and/or signals to and from one or more components of the conformal coating system 100 (e.g., a user input/output 172) to control operation of the conformal coating system 100. The controller 200 may be configured to operate the one or more heaters 126, the transfer mechanism 124, the one or more dispensing assemblies 132, and/or other components of the conformal coating system 100. The controller 200 may include, or be operatively connected to, one or more sensors configured to detect and measure various parameters of the conformal coating system 100.

With continued reference to FIG. 4, the controller 200 may include, or be connected to, one or more position sensors 150. The one or more position sensors 150 may be configured, as described herein, to detect and/or measure a position of one or more components of the conformal coating system 100. By way of non-limiting example, the one or more position sensors 150 may be configured to detect and/or measure a position of the applicator 110 or a portion of the cleaning container 20a.

The controller 200 may include, or be connected to, one or more level sensors 130. The one or more level sensors 130 may be configured, as described herein, to detect and/or measure a level of a fluid in one or more components of the conformal coating system 100. By way of non-limiting example, the one or more level sensors 130 may be configured to detect and/or measure a level of a cleaning fluid 26 in the system reservoir 70 (FIG. 1).

In some aspects, the conformal coating system 100 may include a plurality of position sensors 150 and/or the one or more level sensors 130, and this disclosure is not limited by the particular quantity or respective arrangement of the various sensors described. It should be appreciated that the particular arrangement of the components described above can be according to any suitable arrangement and can depend on dimensions of the individual components selected, the quantity of selected components, on manufacturing constraints, and/or on other considerations common in the industry. The arrangement depicted in the schematic of FIG. 4 is exemplary and is not limiting in terms of relative positioning of the described components.

The conformal coating system 100 may further include a pump 160 configured to provide the coating material to the applicator 110. By way of non-limiting example, in response to a signal from the controller 200 and/or a sensor (e.g., the one or more position sensors 150) that the applicator is in a predetermined position relative to the substrate, the pump 160 may be configured to provide the coating material to the applicator 110.

The conformal coating system 100 may further include an ultrasonic transducer 170. The ultrasonic transducer 170 may be implemented outside the cleaning container 20a. Moreover, in an embodiment, the ultrasonic transducer 170 may be arranged outside the cleaning container 20a and directed toward a location of the applicator 110 during cleaning of the applicator 110. However, the ultrasonic transducer 170 may additionally and/or alternatively be implemented anywhere within the cleaning container 20a while being submerged within the cleaning fluid 26.

Moreover, in some embodiments, the ultrasonic transducer 170 may be arranged within the cleaning container 20a and directed toward a location of the applicator 110 during cleaning of the applicator 110.

The ultrasonic transducer 170 may generally be configured to generate ultrasonic waves through the cleaning fluid 26. So as to avoid the ultrasonic waves from being absorbed or otherwise interfered with, the ultrasonic transducer 170 may be angled obliquely, relative to the vertical axis X, such that the ultrasonic waves are generated at a direction toward the through hole 34 defined by the lid 32, such as is illustrated in FIG. 2A. The ultrasonic transducer 170 may be actuated to generate the ultrasonic waves, as necessary. By way of non-limiting example, in response to a signal from the controller 200 and/or a sensor (e.g., position sensor 150) indicating a position of the applicator 110, and/or the like.

The controller 200 may include a processor 220 configured to receive signals from the one or more level sensors 130 and/or the one or more position sensors 150. Additionally, the controller 200 may include an analog to digital converter, a digital to analog converter, at least one filter, and/or the like to prepare and condition the signals. The received signals may include measured values of fluid level in the system reservoir 70 and/or a position of the applicator 110, respectively. The processor 220 may include a programmable logic controller (PLC), a microprocessor-based controller, a hardened personal computer, or other conventional programmable control device capable of carrying out the functions described herein as will be understood by those of ordinary skill. The processor 220 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The processor 220 may be configured to connect with and communicate with a memory 224 configured to receive and store the measured values. The memory 224 may include a random access memory (RAM) and/or a computer-readable storage medium, such as a read-only memory (ROM) or non-volatile RAM (NVRAM), for storing basic routines for starting and/or operating the processor 220, which may be configured as a controller, and/or another component of the conformal coating system 100 and to transfer information between the various components and devices of the conformal coating system 100. The memory 224 may also store other software components necessary for the operation of the processor 220 and/or other components of the conformal coating system 100 including an operating system, software implementing a cleaning method as described herein, and/or the like. The processor 220 may include, or may be connected to, or otherwise in communication with, computer-readable storage media to store and retrieve information, such as program modules, data structures, or other data. It should be appreciated by those skilled in the art that computer-readable storage media may be any available media that provides for the storage of non-transitory data and that may be accessed by the processor 220. By way of non-limiting example, the computer-readable storage media may include volatile and non-volatile storage media, transitory computer-readable storage media, non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

In an embodiment, the controller 200 includes the controller 44 (FIGS. 1 and 3) or performs the functions of the controller 44.

With continued reference to FIG. 4, the memory 224 may include repositories for measured data 228 and for control data 232. The measured data 228 may include the measured values received from one or more of the one or more level sensors 130, the one or more position sensors 150, and/or another component of the conformal coating system 100. Additionally, the measured data 228 may include acquisition time, other environmental data, and/or the like. The control data 232 may include predefined information that may be preprogrammed into the processor 220 prior to operation of the conformal coating system 100. In operation, the processor 220 may compare the measured data 228 with the control data 232.

The processor 220 may also be configured to transmit one or more signals to one or more components of the conformal coating system 100. In some aspects, the processor 220 may be configured to transmit one or more signals to components outside of the conformal coating system 100, for example, to, or through, a wired connection, a wireless connection, a network connection, a cloud network connection (not shown), and/or the like.

The following are a number of nonlimiting EXAMPLES of aspects of the disclosure.

In one general aspect, applicator cleaning system may include a cleaning container configured to store a cleaning fluid and configured to receive an applicator for cleaning in the cleaning fluid. The applicator cleaning system may also include a leveling system configured to maintain the cleaning fluid in the cleaning container at a predetermined elevation, where the leveling system is configured to output the cleaning fluid at the predetermined elevation; and a pump configured to provide the cleaning fluid to the leveling system such that the leveling system outputs the cleaning fluid at the predetermined elevation. Other embodiments of this aspect include corresponding computer systems, apparatus, and computer programs recorded on one or more computer storage devices, each configured to perform the actions of the methods.

Implementations may include one or more of the following features. Applicator cleaning system where the pump is configured to constantly output the cleaning fluid to the leveling system. The applicator cleaning system where the leveling system includes an overflow receptacle and a leveling reservoir that is fluidly coupled to the cleaning container such that when the cleaning fluid in the leveling reservoir is at the predetermined elevation the cleaning fluid in the cleaning container is at the predetermined elevation, and where the leveling reservoir is configured to output an excess of the cleaning fluid at the predetermined elevation to the overflow receptacle of the leveling system. The applicator cleaning system where the overflow receptacle is configured to return the excess of the cleaning fluid to a system reservoir. The applicator cleaning system where the leveling reservoir is configured to maintain the cleaning fluid at the predetermined elevation by cascading excess cleaning fluid into the overflow receptacle. The applicator cleaning system where the leveling reservoir may include an open top such that the excess cleaning fluid cascades from the leveling reservoir at the predetermined elevation into the overflow receptacle. The applicator cleaning system where the leveling reservoir is a first leveling reservoir, the predetermined elevation is a first predetermined elevation, and the leveling system includes a second leveling reservoir that outputs the cleaning fluid at a second predetermined elevation. The applicator cleaning system, where the leveling reservoir is remote from the cleaning container. The applicator cleaning system may include a quick connect configured to releasably couple a fluid line, that is fluidly coupled to the cleaning container, to the leveling reservoir. The applicator cleaning system may include: a flow sensor configured to measure a flow rate of the cleaning fluid from the pump into the leveling system; and a controller configured to maintain the flow rate at or above a predetermined threshold, such that the cleaning fluid in the leveling system is maintained at the predetermined elevation. The applicator cleaning system may include: a fluid level sensor configured to measure an elevation of the cleaning fluid in the leveling system; and a controller configured to maintain the level of cleaning fluid in the leveling system at the predetermined elevation. The applicator cleaning system, where the applicator cleaning system includes a flow control valve configured to adjust flow of cleaning fluid from the pump to the leveling system. The applicator cleaning system, where the applicator cleaning system includes a check valve configured to allow the cleaning fluid to flow from the leveling system to the cleaning container, and configured to not allow fluid to flow from the cleaning container to the leveling system. The applicator cleaning system, where the cleaning container includes an opening above the predetermined elevation by which to receive the applicator for cleaning in the cleaning fluid. The applicator cleaning system, where the leveling system is configured to move up and down relative to the cleaning container. The applicator cleaning system, where the cleaning container is configured to move up and down relative to the leveling system. The applicator cleaning system, where the cleaning container does not include fluid level sensor that is configured to measure a level of cleaning fluid in the cleaning container. The applicator cleaning system, where the leveling system includes the cleaning container, such that pump is configured to provide the cleaning fluid to the cleaning container such that the cleaning container outputs the cleaning fluid at the predetermined elevation. The applicator cleaning system where the leveling system includes an overflow receptacle that is configured to receive the cleaning fluid that is output from the cleaning container. A coating system may include the applicator cleaning system and the applicator. The coating system further including one or more additional cleaning containers and one or more additional applicators. The coating system where the coating system is a conformal coating system. A method of using the applicator cleaning system or the coating system having: constantly pumping the cleaning fluid with the pump to the leveling system such that the leveling system outputs the cleaning fluid at the predetermined elevation, thereby maintaining the cleaning fluid in the cleaning container at the predetermined elevation. Implementations of the described techniques may include hardware, a method or process, or a computer tangible medium.

In one general aspect, applicator cleaning system may include a cleaning container configured to store a cleaning fluid and configured to receive an applicator for cleaning in the cleaning fluid. The applicator cleaning system may also include a leveling system that is configured to maintain the cleaning fluid in the cleaning container at a predetermined elevation, where the leveling system includes a leveling reservoir that is fluidly coupled to the cleaning container such that when the cleaning fluid in the leveling reservoir is at the predetermined elevation the cleaning fluid in the cleaning container is at the predetermined elevation; and a pump configured to provide the cleaning fluid to the leveling reservoir. Other embodiments of this aspect include corresponding computer systems, apparatus, and computer programs recorded on one or more computer storage devices, each configured to perform the actions of the methods.

Implementations may include one or more of the following features. The applicator cleaning system where the leveling system further includes an overflow receptacle, where the leveling reservoir is configured such that when the leveling reservoir is filled with the cleaning fluid, excess cleaning fluid provided by the pump to the leveling reservoir cascades at the predetermined elevation from the leveling reservoir into the overflow receptacle. The applicator cleaning system where the pump is configured to provide the cleaning fluid to the leveling reservoir such that the excess cleaning fluid cascades at the predetermined elevation from the leveling reservoir into the overflow receptacle. The applicator cleaning system where the overflow receptacle is configured to return the excess cleaning fluid to a system reservoir for supplying the cleaning fluid to the pump. The applicator cleaning system, where the pump is configured to constantly output the cleaning fluid to the leveling system. The applicator cleaning system, where the leveling reservoir is a first leveling reservoir, the predetermined elevation is a first predetermined elevation, and the leveling system includes a second leveling reservoir that outputs the cleaning fluid at a second predetermined elevation. The applicator cleaning system, where the leveling reservoir is remote from the cleaning container. The applicator cleaning system may include a quick connect configured to releasably couple a fluid line, that is fluidly coupled to the cleaning container, to the leveling reservoir. The applicator cleaning system may include: a flow sensor configured to measure a flow rate of the cleaning fluid from the pump into the leveling system; and a controller configured to maintain the flow rate at or above a predetermined threshold, such that the cleaning fluid in the leveling system is maintained at the predetermined elevation. The applicator cleaning system, where the cleaning container does not include fluid level sensor that is configured to measure a level of cleaning fluid in the cleaning container. A coating system may include the applicator cleaning system and the applicator. The coating system further including one or more additional cleaning containers and one or more additional applicators. The coating system where the coating system is a conformal coating system. A method of using the applicator cleaning system or the coating system, having: constantly pumping the cleaning fluid with the pump to the leveling system such that the leveling system outputs the cleaning fluid at the predetermined elevation, thereby maintaining the cleaning fluid in the cleaning container at the predetermined elevation. Implementations of the described techniques may include hardware, a method or process, or a computer tangible medium.

It should be noted that the illustrations and descriptions of the examples shown in the figures are for exemplary purposes only, and should not be construed limiting the disclosure. One skilled in the art will appreciate that the present disclosure contemplates various examples. Additionally, it should be understood that the concepts described above with the above-described examples may be employed alone or in combination with any of the other examples described above. It should further be appreciated that the various alternative examples described above with respect to one illustrated example can apply to all examples as described herein, unless otherwise indicated.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more examples or that one or more examples necessarily include these features, elements and/or steps. The terms “comprising,” “including,” “having,” and the like are synonymous and are used inclusively, in an open-ended fashion, and do not exclude additional elements, features, acts, operations, and so forth.

Although the disclosure has been described in detail, it should be understood that various changes, substitutions, and alterations can be made herein without departing from the spirit and scope of the present disclosure as defined by the appended claims. Additionally, any of the embodiments disclosed herein can incorporate features disclosed with respect to any of the other embodiments disclosed herein. Moreover, the scope of the present disclosure is not intended to be limited to the particular embodiments described in the specification. As one of ordinary skill in the art will readily appreciate from that processes, machines, manufacture, composition of matter, means, methods, or steps, presently existing or later to be developed that perform substantially the same function or achieve substantially the same result as the corresponding embodiments described herein may be utilized according to the present disclosure.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be understood that reference herein to “a” or “one” to describe a feature such as a component or step does not foreclose additional features or multiples of the feature. For instance, reference to a device having or defining “one” of a feature does not preclude the device from having or defining more than one of the feature, as long as the device has or defines at least one of the feature. Similarly, reference herein to “one of” a plurality of features does not foreclose the invention from including two or more, up to all, of the features. For instance, reference to a device having or defining “one of a X and Y” does not foreclose the device from having both the X and Y.

1. An applicator cleaning system comprising:
a cleaning container configured to store a cleaning fluid and configured to receive an applicator for cleaning in the cleaning fluid;
a leveling system configured to maintain the cleaning fluid in the cleaning container at a predetermined elevation, wherein the leveling system is configured to output the cleaning fluid at the predetermined elevation; and
a pump configured to provide the cleaning fluid to the leveling system such that the leveling system outputs the cleaning fluid at the predetermined elevation.

2. The applicator cleaning system of claim 1, wherein the pump is configured to constantly output the cleaning fluid to the leveling system.

3. The applicator cleaning system of claim 1, wherein the leveling system includes an overflow receptacle and a leveling reservoir that is fluidly coupled to the cleaning container such that when the cleaning fluid in the leveling reservoir is at the predetermined elevation the cleaning fluid in the cleaning container is at the predetermined elevation, wherein the leveling reservoir is configured to output an excess of the cleaning fluid at the predetermined elevation to the overflow receptacle of the leveling system, wherein the leveling reservoir is configured to maintain the cleaning fluid at the predetermined elevation by cascading excess cleaning fluid into the overflow receptacle, and wherein the leveling reservoir comprises an open top such that the excess cleaning fluid cascades from the leveling reservoir at the predetermined elevation into the overflow receptacle.

4-6. (canceled)

7. The applicator cleaning system of claim 3, wherein the leveling reservoir is a first leveling reservoir, the predetermined elevation is a first predetermined elevation, and the leveling system includes a second leveling reservoir that outputs the cleaning fluid at a second predetermined elevation.

8. The applicator cleaning system of claim 3, wherein the leveling reservoir is remote from the cleaning container.

9. (canceled)

10. The applicator cleaning system of claim 1, further comprising:
a flow sensor configured to measure a flow rate of the cleaning fluid from the pump into the leveling system; and
a controller configured to maintain the flow rate at or above a predetermined threshold, such that the cleaning fluid in the leveling system is maintained at the predetermined elevation.

11-12. (canceled)

13. The applicator cleaning system of claim 1, wherein the applicator cleaning system includes a check valve configured to allow the cleaning fluid to flow from the leveling system to the cleaning container, and configured to not allow fluid to flow from the cleaning container to the leveling system.

14. (canceled)

15. The applicator cleaning system of claim 1, wherein the leveling system is configured to move up and down relative to the cleaning container and/or wherein the cleaning container is configured to move up and down relative to the leveling system.

16-17. (canceled)

18. The applicator cleaning system of claim 1, wherein the leveling system includes the cleaning container, such that the pump is configured to provide the cleaning fluid to the cleaning container such that the cleaning container outputs the cleaning fluid at the predetermined elevation.

19. (canceled)

20. A coating system including:
the applicator cleaning system of claim 1,
the applicator.

21. The coating system of claim 20, further including one or more additional cleaning containers and one or more additional applicators.

22. (canceled)

23. A method of using the applicator cleaning system of claim 1, comprising:
constantly pumping the cleaning fluid with the pump to the leveling system such that the leveling system outputs the cleaning fluid at the predetermined elevation, thereby maintaining the cleaning fluid in the cleaning container at the predetermined elevation.

24. An applicator cleaning system comprising:
a cleaning container configured to store a cleaning fluid and configured to receive an applicator for cleaning in the cleaning fluid;
a leveling system that is configured to maintain the cleaning fluid in the cleaning container at a predetermined elevation, wherein the leveling system includes a leveling reservoir that is fluidly coupled to the cleaning container such that when the cleaning fluid in the leveling reservoir is at the predetermined elevation the cleaning fluid in the cleaning container is at the predetermined elevation; and
a pump configured to provide the cleaning fluid to the leveling reservoir.

25. The applicator cleaning system of claim 24, wherein the leveling system further includes an overflow receptacle, wherein the leveling reservoir is configured such that when the leveling reservoir is filled with the cleaning fluid, excess cleaning fluid provided by the pump to the leveling reservoir cascades at the predetermined elevation from the leveling reservoir into the overflow receptacle.

26. The applicator cleaning system of claim 25, wherein the pump is configured to provide the cleaning fluid to the leveling reservoir such that the excess cleaning fluid cascades at the predetermined elevation from the leveling reservoir into the overflow receptacle.

27-33. (canceled)

34. A coating system including:
the applicator cleaning system of claim 24,
the applicator.

35-37. (canceled)

38. A method of implementing an applicator cleaning system comprising:
storing a cleaning fluid in a cleaning container and configuring the cleaning container to receive an applicator for cleaning in the cleaning fluid;
maintaining the cleaning fluid in the cleaning container at a predetermined elevation with a leveling system, wherein the leveling system is configured to output the cleaning fluid at the predetermined elevation; and
providing the cleaning fluid to the leveling system with a pump such that the leveling system outputs the cleaning fluid at the predetermined elevation.

39. The method of implementing an applicator cleaning system of claim 38, wherein the pump constantly outputs the cleaning fluid to the leveling system.

40. The method of implementing an applicator cleaning system of claim 38, wherein the leveling system includes an overflow receptacle and a leveling reservoir that is fluidly coupled to the cleaning container such that when the cleaning fluid in the leveling reservoir is at the predetermined elevation the cleaning fluid in the cleaning container is at the predetermined elevation, wherein the leveling reservoir outputs an excess of the cleaning fluid at the predetermined elevation to the overflow receptacle of the leveling system, and wherein the leveling reservoir maintains the cleaning fluid at the predetermined elevation by cascading excess cleaning fluid into the overflow receptacle.

41-46. (canceled)

47. The method of implementing an applicator cleaning system of claim 38, further comprising:
measuring a flow rate of the cleaning fluid from the pump into the leveling system with a flow sensor; and
maintaining the flow rate at or above a predetermined threshold with a controller, such that the cleaning fluid in the leveling system is maintained at the predetermined elevation.

48-56. (canceled)
